(19) United States
(12) Patent Application Publication
(10) Pub. No.: US 2007/0168195 A1
(43) Pub. Date: Jul. 19, 2007

(54) Method and system for measurement of voice quality using coded signals

(76) Inventors: George P. Wilkin, Bolingbrook, IL (US); Gerald W. Pfleging, Batavia, IL (US); David A. Zahn, Naperville, IL (US)

Correspondence Address: FAY SHARPE/LUCENT, 1100 SUPERIOR AVE, SEVENTH FLOOR, CLEVELAND, OH, 44114, US

(21) Appl. No.: 11/335,230

(22) Filed: Jan. 19, 2006

(51) Int. Cl. G10L 21/00

(52) U.S. Cl. 704/270

(57) ABSTRACT

A method for end-to-end network testing in a Voice over Internet Protocol (VoIP) network. The method includes generating a signature signal at one compatible device, transmitting the signature signal to another compatible device, receiving that signature signal and comparing it to a recognized signal. The method also includes storing the received signal for a technician to evaluate at a later time and computing a quantitative value for the Quality of Service (QoS). The compatible device can be a switch, a gateway, an end device, etc. As described, this technique requires no dedicated test equipment and should provide an advantage to the user and manufacturers of VoIP equipment.

### BACKGROUND OF THE INVENTION

This invention relates to a method and system for testing the quality of a voice-over-internet-protocol (VoIP) network and more particularly, to a method and system for end-to-end network testing of voice and path quality in a VoIP network.

While the invention is particularly directed to the art of VoIP telephony, and will be thus described with specific reference thereto, it will F be appreciated that the invention may have usefulness in other fields and applications. For example, the invention may be used in cellular and traditional phone systems.

By way of background, a VoIP network converts analog audio data to digital data that can be transmitted over the internet. Many phone companies use VoIP to streamline networks by routing thousands of phone calls through a circuit switch and into an IP gateway. Among other functions, the gateway compresses the data and transmits the data through the network. Once the call is received by a destination gateway, the call is decompressed, reassembled and routed to a local circuit switch.

VoIP technology is gaining popularity as a way to transfer voice data. Because of numerous economic and infrastructure benefits, VoIP is a viable alternative to traditional phone service in some circumstances. However, in order to become major competitor, VoIP technology must match the level of quality of traditional phone service, which it has yet to do.

VoIP technology, in many respects, is more sensitive than other forms of audio/voice transmission. Many factors, including excessive bandwidth usage and out of order packets, contribute to poor voice transmission. Notably, these factors typically only have a very minor effect on data transmission quality. Although the average customer may not notice the reduction in quality for strict data transmission, the average customer would likely (and indeed does) notice the drop in voice quality when these difficulties are encountered. However, when a relatively small amount of packets are lost or out of order, it can cause many noticeable problems such as jitter and latency which, in turn, can cause echo problems and/or dropouts. These problems render VoIP technology less desirable to the average user than traditional phone service.

VoIP technology service providers are equipped to correct many of these problems. However, in order to do so, the service provider must be aware of the problems and be able to track the source of the problems. This makes it desirable to have a method to test the voice quality of the system so problems can be corrected quickly and effectively.

Furthermore, it is desirable in the industry to quantitatively measure the quality of VoIP service in order to prioritize problems and intercept major problem areas quickly. It is also desirable to measure the quality of the VoIP service through an automated process. In this manner, testing can be done more frequently and without the intervention of a technician. It is also desirable to conduct frequent testing that will not adversely impact the average end user.

The present invention contemplates a new and improved testing method and system that resolves the above-referenced difficulties and others.

### SUMMARY OF THE INVENTION

A method and system for measurement of voice quality using coded signals is provided.

In one aspect of the presently described embodiments, a method for end-to-end network testing in a voice over internet protocol network comprises generating a signature signal at a first compatible device, transmitting said signature signal to a second compatible device, receiving said signature signal at said second compatible device and comparing said received signature signal to a recognized signal at said second compatible device.

In another aspect of the presently described embodiments, the signature signal as an inaudible tone.

In another aspect of the presently described embodiments, the method is implemented in predetermined intervals.

In another aspect of the presently described embodiments, the method further comprises deriving a quantitative value based upon said comparison.

In another aspect of the presently described embodiments, the method further comprises deriving an estimated mean opinion score.

In another aspect of the presently described embodiments, the method further comprises storing said received signature signal enabling a prior path trace record to be used to debug errors.

In another aspect of the presently described embodiments, the method further comprises employing a switch as said first or second compatible device.

In another aspect of the presently described embodiments, the method further comprises implementing switch to switch communication.

In another aspect of the presently described embodiments, the method further comprises employing a gateway as said first or second compatible device.

In another aspect of the presently described embodiments, the method further comprises employing an end device as said first or second compatible device.

In another aspect of the presently described embodiments, the testing is conducted over a communication path that is between said compatible devices.

In another aspect of the presently described embodiments, a VoIP test enabling system comprises a transmission module operative to generate a signature signal and send said signature signal through a voice over internet protocol network, a testing module operative to receive said transmitted signature signal and compare said signature signal with a stored recognized signal and a plurality of compatible devices, wherein at least one compatible device comprises said transmission module and at least another compatible device comprises said testing module.

In another aspect of the presently described embodiments, the testing module comprises testing logic capable of detecting problems in the network.

In another aspect of the presently described embodiments, the testing module comprises memory.

In another aspect of the presently described embodiments, the transmission module comprises generator logic.

In another aspect of the presently described embodiments, an end-to-end network testing method in a voice over internet protocol network comprises generating a signature signal at a switch, transmitting said signature signal to a compatible device, wherein said compatible device is adapted to capture said signature signal and comparing said signature signal to a recognized signal at said compatible device.

In another aspect of the presently described embodiments, the method further comprises storing said received signature signal enabling a prior path trace record to be used to debug errors.

In another aspect of the presently described embodiments, the method further comprises employing a gateway as said compatible device.

In another aspect of the presently described embodiments, the method further comprises employing a second switch as said compatible device.

In another aspect of the presently described embodiments, the method further comprises employing an end device as said compatible device.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a portion of the communications network including a network and a compatible device in accordance with the invention.

FIG. 2 illustrates a portion of the communications network including an IP network, switches, gateways and end devices in accordance with the invention.

FIG. 3 is a flowchart illustrating a method according the present invention.

FIG. 4 illustrates a device according to an embodiment of the present invention.

FIG. 5 illustrates a testing logic according to an embodiment of the present invention.

### DETAILED DESCRIPTION OF THE PREFERRED EMBODIMENTS

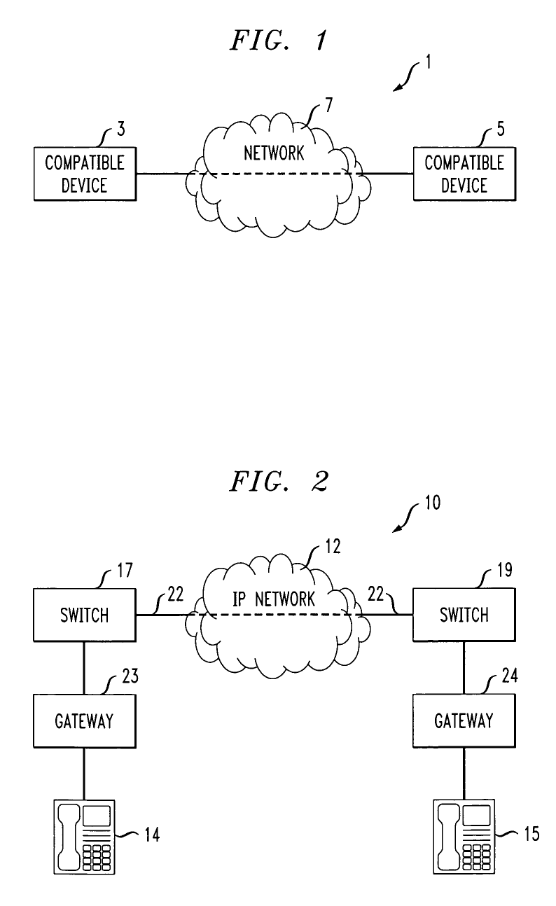

Referring now to the drawings wherein the showings are for purposes of illustrating the preferred embodiments of the invention only and not for purposes of limiting same, FIG. 1 provides a view of an overall system into which the present invention may be incorporated. A communications network infrastructure 1 is shown generally.

The communications network infrastructure 1 includes two compatible devices 3, 5 and a network 7. The two compatible devices 3, 5 are connected through the network 7 (e.g., the Internet). It should be understood that the compatible devices could also be connected to a plurality of different devices throughout the network. It should also be understood that the compatible device can be a variety of communication devices or network elements including gateways, switches, telephones, laptops, etc.

As described in detail below, the invention includes a method for end-to-end testing in a VoIP network. It comprises generating a signature signal at a first compatible device 3 and transmitting that signal from the first compatible device 3 to the second compatible device 5. The signal is received at the second compatible device 5 and compared to a recognized signal at the second compatible device 5. The results of this comparison are then used by the system to determine if there is a voice quality issue to address.

Referring now to FIG. 2, in this embodiment, the gateways 23, 24 are primarily operative to translate the call from its current format to a format capable of transport over the IP network 12. The gateways 23, 24 support any suitable form of connection including but not limited to POTS, ISDN, IP telephony, etc. For illustrative purposes, the end devices 14, 15 are shown as IP telephones, e.g., used to conduct a VoIP call. However, it is to be appreciated that the end devices 14, 15 may be any appropriate type of end device as is known in the art for conducting various types of calls, e.g., IP, voice, data, multimedia, etc. As shown, the end devices 14, 15 are operative as consumer premises equipment (CPE), which may be traditional telephones, audio-equipped personal computers, single use appliances, mobile telephones, etc. The switches 17, 19 are operative to map and connect calls to one another.

In this example system of FIG. 2, the first switch 17 is the first compatible device and the second end device 15 is the second compatible device. As shown, between the two compatible devices are the IP network 12, another switch 19, and a gateway 24. It should be appreciated that numerous devices can be between the two compatible devices including other compatible devices. For example, in FIG. 2, the second gateway 24 could also be a compatible device. If, by way of example, the two switches 19 and 17 were the compatible devices, the-switches could not only monitor the connection, but they could also test the connection by themselves via switch to switch communication.

In operation, the network 10 provides voice and path quality testing. In one form, a signature signal is generated at the first switch 17. The signature signal is transmitted from the first switch 17 to the second end device 15. The signal is received at the second end device 15 and compared to a recognized signal at the second end device 15. As will be detailed below, in one form, the recognized signal is stored in a suitable location at the second end device 15. The results of this comparison are then used by the system to determine if there is a voice quality issue to address. Of course, the recognized signal could be stored at a variety of other locations, including databases that can be accessed by the second end device 15. As described, this technique requires no dedicated test equipment and should provide an advantage to the user and manufacturers of VoIP equipment.

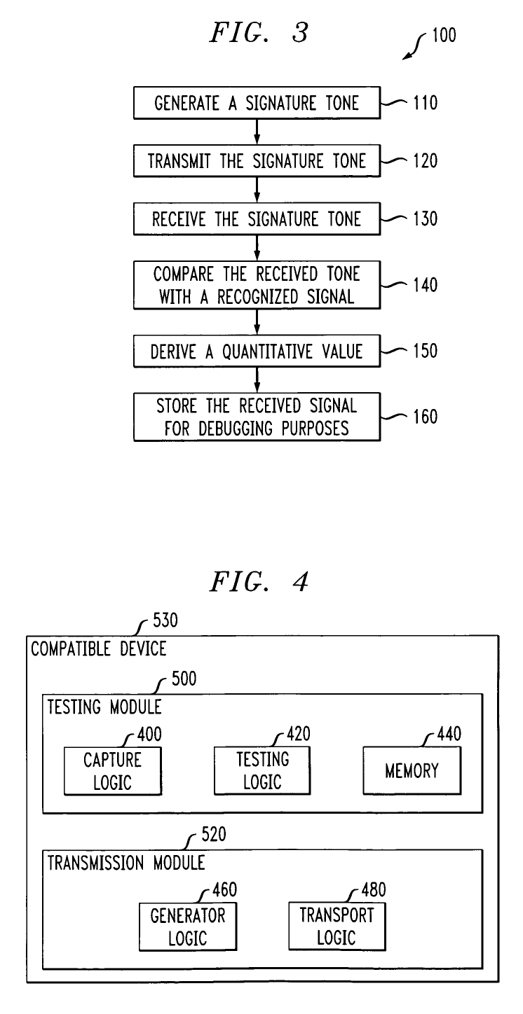

Referring to FIG. 3, a method of end-to-end network testing is shown generally at 100. It should be understood that the method 100 may be implemented using a variety of software and hardware configurations. In one form, the software implementing the method of FIG. 3 resides on either or both switches 17, 19. In another form the software implementing the method of FIG. 3 resides on either or both gateways 23, 24. In yet another form, the method resides in either or both end devices 14, 15. In yet another form, the software is suitably distributed among various network elements.

This testing method 100 can be accomplished at various times. For example, in one embodiment, this testing method is performed continuously. In another embodiment, it is performed only after disconnects. In another embodiment, the method is performed at every tenth call. In another embodiment, the method is performed every other day or at some other specific predetermined interval. In yet another embodiment, this testing method is performed every time the user calls the voice mail system. In yet another embodiment, the method is performed as soon as a call begins. In yet another embodiment, the method is performed while the phone ringing. In yet another embodiment, this testing method is performed only on demand. The system is flexible enough to allow for the method to be performed at any time. But regardless of when it is performed, if it is conducted over time, it can provide a more accurate depiction of the Quality of Service (QoS).

The method 100 includes generating a signature signal at a first compatible device (at 110). When generating a signature signal, the signature signal can take the form of any measurable noise. In one embodiment, the signature signal is inaudible to the human ear. In another embodiment, the signature signal is 3 to 4 seconds long. The longer the signal and more varied in frequency (e.g. tone, pitch), the more accurate the test, however, the signature signal is not required to be any particular length or frequency.

The signature signal is then transmitted to a second compatible device (at 120). Of course, the QoS is evaluated between the compatible device that sends the signature signal and the compatible device that receives the signature signal. In this regard, the signature signal is then transmitted from the switch 17 to the second compatible device, e.g. the end device 15, as shown in FIG. 2. Therefore, the QoS is evaluated between the switch 17 and the end device 15, the two compatible devices. When the end devices 14, 15 are both compatible devices, the claimed invention is capable of end-to-end testing. In such a case, the QoS is determined between the two compatible devices 14 and 15.

The signature signal is received at said second compatible device (at 130) and compared to a recognized signal at second compatible device (at 140). In this regard, the signature signal is received by the end device 15. The end device 15 can then compare the received signature signal with a recognized signal. In at least one form, the recognized signal is a signal stored in the end device 15 that is equivalent to the signature signal. Therefore, if the signature signal is sent without incident, e.g. no packets were lost in the transmission, the received signal and the recognized signal would be identical.

After the end device makes a comparison (at 140), the end device 15 can derive a quantitative value (at 150) based upon the comparison. This comparison is discussed in further detail below.

The method further includes storing the received signal for debugging purposes (at 160). Along these lines, the end device 15 can store the received signal in its memory 440 (FIG. 4). The received signal can then be reevaluated at a later time. A technician can use the stored signal and run a packet path-trace record in order to debug errors in the system.

As noted, the compatible devices described herein may take a variety of forms and may perform functions other than end-to-end testing. Indeed, an advantage of the system according to the presently described embodiments is that dedicated test equipment is not required. The compatible device may be a variety of devices including but not limited to gateways, switches and end devices.

Referring now to FIG. 4, in this embodiment the compatible device 530 has the ability to both send and receive signature signals. However, it is not required that a compatible device be enabled to do both.

In this embodiment, the compatible device 530 contains a testing module 500 and a transmission module 520 which will enable the device 530 to be either the first or second compatible device 3, 5.

The transmission module 520 contains generator logic 460 and transport logic 480. The generator logic 460 is capable of generating the signature signal 110. As noted above, the signature signal can be one of a variety of different sounds. The transport logic 480 is capable of sending the generated signature signal across the network 12 to a second compatible device 530.

The testing module 500 contains capture logic 400, testing logic 420 and memory 440. The capture logic 400 is operative to receive the generated signal and capture it. Once the sent signal is captured, it can be tested and stored in memory for later use. The capture logic 400, used in conjunction with the memory, can allow for a technician to hear the received signal as some later date. The memory 440 is operative to store the received signal for debugging purposes and it can further be used to store the recognized signal.

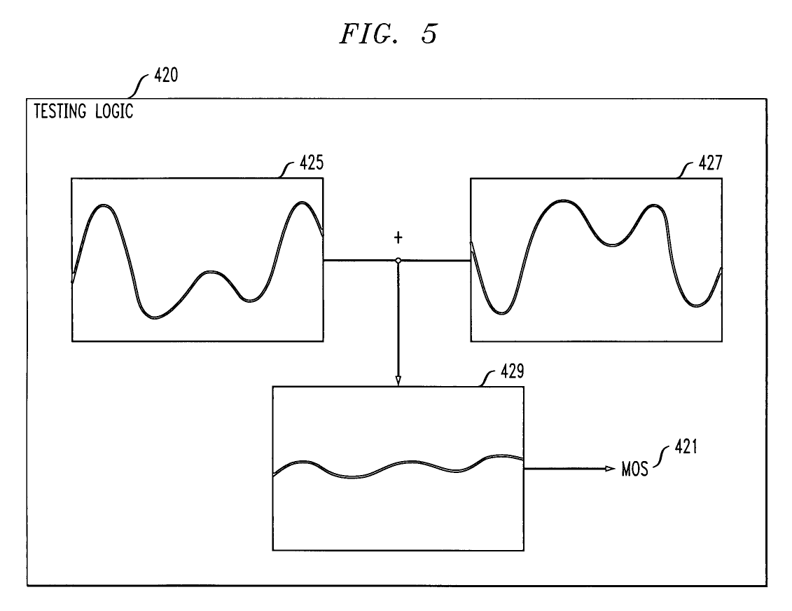

The testing module 500 further comprises testing logic 420, that may take a variety of forms. Referring to FIG. 5, in one form, the testing logic 420 is operative to run a differential equation that compares the received signature signal 425 to the recognized signal 427. The difference between the two signals 429 will yield the quantitative score 421 that conveys the QoS of the system between the two compatible devices 17, 15. The derived quantitative score 421 can be calculated to be one of many quantitative values, including but not limited to a mean opinion score (MOS) 421.

When debugging the system, a map can be developed to chart each variable to the source of the problem, greatly assisting a technician in debugging the system's errors. For example, using a map, one skilled in the art will be able to conclude that when a signature signal is 2 milliseconds too short, packets are being dropped or they are out of order. The map could also tell a technician that when the signature signal is shifted higher or lower in frequency there are problems with the level of bandwidth usage.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for network testing in a voice over internet protocol network comprising:
generating a signature signal at a first compatible device;
transmitting said signature signal to a second compatible device;
receiving said signature signal at said second compatible device; and
comparing said received signature signal to a recognized signal at said second compatible device.

2. A method as set forth in claim 1 further comprising generating said signature signal as an inaudible tone.

3. A method as set forth in claim 1 wherein said method is implemented in predetermined intervals.

4. A method as set forth in claim 1 further comprising deriving a quantitative value based upon said comparison.

5. A method as set forth in claim 4 further comprising deriving an estimated mean opinion score.

6. A method as set forth in claim 1 further comprising storing said received signature signal enabling a path trace to be used to debug errors.

7. A method as set forth in claim 1 further comprising employing a switch as said first or second compatible device.

8. The method as set forth in claim 7 further comprising implementing switch to switch communication.

9. A method as set forth in claim 1 further comprising employing a gateway as said first or second-compatible device.

10. A method as set forth in claim 1 further comprising employing an end device as said first or second compatible device.

11. A method as set forth in claim 1, wherein said testing is conducted over a communication path that is between said compatible devices.

12. A VoIP test enabling system comprising:
a transmission module operative to generate a signature signal and send said signature signal through a voice over internet protocol network;
a testing module operative to receive said transmitted signature signal and compare said signature signal with a stored recognized signal; and
a plurality of compatible devices, wherein at least one compatible device comprises said transmission module and at least another compatible device comprises said testing module.

13. A network as set forth in claim 12 wherein said testing module comprises testing logic capable of detecting problems in the network.

14. A network as set forth in claim 12 wherein said testing module comprises memory.

15. A network as set forth in claim 12 wherein said transmission module comprises generator logic.

16. An end-to-end network testing method in a voice over internet protocol network comprising:
generating a signature signal at a switch;
transmitting said signature signal to a compatible device, wherein said compatible device is adapted to capture said signature signal; and
comparing said signature signal to a recognized signal at said compatible device.

17. A method as set forth in claim 16 further comprising storing said received signature signal enabling a prior path trace record to be used to debug errors.

18. The method as set forth in claim 16 further comprising employing a gateway as said compatible device.

19. The method as set forth in claim 16 further comprising employing a second switch as said compatible device.

20. The method as set forth in claim 16 further comprising employing an end device as said compatible device.
